(19) United States
(12) Patent Application Publication
(10) Pub. No.: US 2003/0065575 A1
(43) Pub. Date: Apr. 3, 2003

(54) Wireless access grocery store printer appliance

(76) Inventor: Alan C. Berkema, Granite Bay, CA (US)

Correspondence Address: HEWLETT-PACKARD COMPANY, Intellectual Property Administration, P. O. Box 272400, Fort Collins, CO, 80527-2400, US

(21) Appl. No.: 09/969,472

(22) Filed: Oct. 2, 2001

(51) Int. Cl. G06F 17/60

(52) U.S. Cl. 705/26

(57) ABSTRACT

A grocery store shopping list generation system for entering, organizing and printing a grocery shopping list. The system employs a mobile unit that includes applicable software to allow the user to enter and store items found in a grocery store. The mobile unit could respond to user entries by suggesting related or accompanying items. The list is transmitted from the mobile unit to a processor at the store for printing. The processor accesses a store database to identify available store items. The processor also sorts and organizes the items on the list by related items, and may identify where such items can be found in a store. The processor also modifies the list based on stored user preferences, or standard store information.

### BACKGROUND OF THE INVENTION

1. Field of the Invention

This invention relates generally to a shopping list generation system for entering, organizing and printing a shopping list and, more particularly, to a shopping list generation system employing a mobile unit in wireless communication with a processor at a grocery store, where a grocery list is entered into the mobile unit and is transmitted to the processor for organization and printing.

2. Discussion of the Related Art

As technology advances, small, hand-held electronic units have been made available that are intended to make a user's life more convenient. For example, personal digital assistants (PDAs), such as Palm Pilots™, are well known electronic devices that allow a user to input information therein where it is organized and displayed for future use. These hand-held units sometimes include software that makes them compatible with larger processors where information can be transferred and downloaded. Often times this connection between the mobile unit and the computer is hardwired, but in some systems, the mobile unit communicates with the processor in a wireless manner. Known protocols that allow such a wireless communication include “blue tooth” and IEEE 802.11 protocols. As is known in the art, blue tooth is a short range information transmission protocol and IEEE 802.11 is a long range information transmission protocol at the same frequency both transmitting at about 2.5 GHz.

One area where PDAs and other devices are employed to make the user's life more convenient is in the generation of grocery shopping lists. The hand-held unit includes software that allows the user to enter shopping items into the unit that can be combined with other items to generate the shopping list. One known system that provides this convenience is available from IBM and includes the use of a Palm Pilot and specialized software. The grocery list is entered into the Palm Pilot, and the list is submitted to the grocery store through an internet connection. Attendants at the grocery store then collect and package the items on the grocery list for the customer, who then goes to the store to pick up the items. Such a system does provide user convenience, but can be improved upon or modified for other related applications.

### SUMMARY OF THE INVENTION

In accordance with the teachings of the present invention, a system for entering, organizing and printing a grocery shopping list is disclosed. The system employs a mobile unit that includes applicable software to allow the user to enter and store items found in a grocery store. The mobile unit could respond to user entries by suggesting related or accompanying items. The mobile unit could also store user favorites or items associated with a particular recipe. The mobile unit is then taken by the user to the grocery store that has a compatible processor.

The grocery list is transmitted from the mobile unit to the processor at the store by a wireless or wired connection. The processor accesses a store database to identify available store items. The processor also sorts and organizes the shopping list by related items, and may identify where such items can be found in the store, such as the applicable aisle number. The processor identifies a user identification code in the transmission, and determines if a user profile is stored for that code in the database. If a user profile is found, then the processor may add customized information about the user's preferences to the list. The processor also may include other standard information, such as store sales and price comparison of items on the list. The processor then prints the list for the user who then selects the items from the list in the store.

Additional objects, advantages, and features of the present invention will become apparent from the following description and appended claims, taken in conjunction with the accompanying drawings.

### BRIEF DESCRIPTION OF THE DRAWINGS

FIG. 1 is a block diagram of a grocery store shopping list generation system, according to an embodiment of the present invention; and

FIGS. 2(a)-2(b) is a flow chart diagram showing the operation of the shopping list generation system depicted in FIG. 1.

### DETAILED DESCRIPTION OF THE EMBODIMENTS

The following discussion of the embodiments of the invention directed to a grocery store shopping list generation system is merely exemplary in nature, and is in no way intended to limit the invention or its applications or uses. For example, the system described below has particular application for generating and printing grocery store shopping lists, but has application for other types of stores.

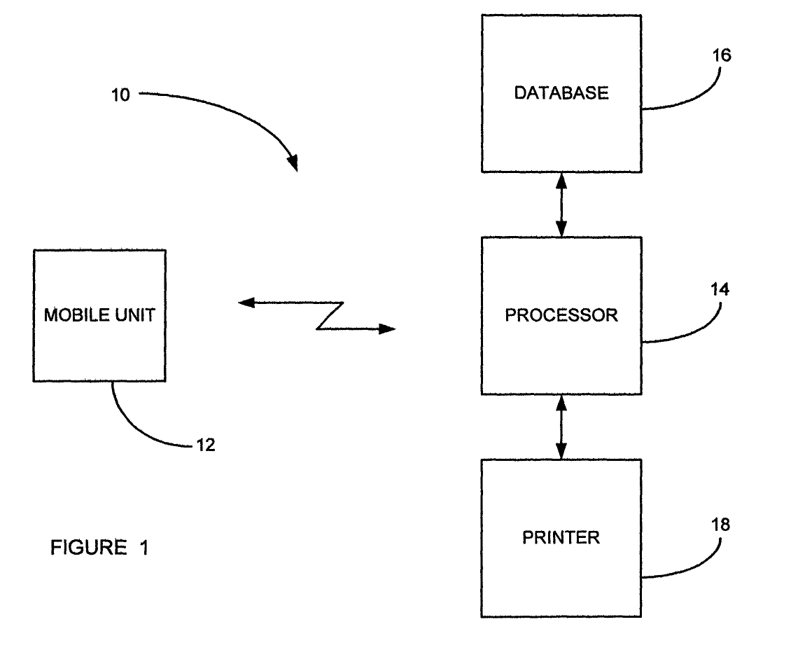

FIG. 1 is a block diagram of a grocery store shopping list generation system 10, according to an embodiment of the present invention. The system 10 employs a mobile unit 12 that includes applicable software, discussed below, that allows a user to enter items into the unit 12 that will later be generated into a shopping list. The system 10 has particular application for generating a grocery store shopping list, but as will be appreciated by those skilled in the art, can be used for any type of shopping list. The mobile unit 12 can be any unit suitable for the purposes described herein, such as a specialized PDA, a Hewlett-Packard's Jornada, a Palm Pilot, a cell phone, a pocket PC, etc.

The unit 12 can run any applicable software suitable for the purposes described herein, such as Windows CE. The software could be loaded into the unit 12 by any suitable technique, such as from a CD or from the internet. The unit 12 is intended to be carried by the user who will then enter items to be included on the list at those times that such items may occur to the user. For example, the user may be at work and decide what he or she would like for dinner, and then input those items required for that dinner selection into the unit 12. Further, the user can use the mobile unit 12 as the user peruses his pantry or refrigerator to enter items as necessary. The mobile unit 12 can include software that provides drop down menus categorizing items, and can identifying favorites, recipes, recipe instructions, etc. that can be entered into the list. The unit 12 can be configured to enter information in any known technique, including downloading items to be entered from the internet. For example, the mobile unit 12 can include a barcode wand (not shown) that is able to scan items to be entered into the unit 12.

When the user goes to the grocery store with the unit 12, he will transmit the shopping list from the unit 12 to a processor 14 at the store. In one embodiment, the software allows the grocery list to be transmitted in a wireless manner to the processor 14. In this embodiment, the mobile unit 12 would have to be within a certain distance from the processor 12, for example six feet, to make the wireless connection. Any suitable transmission protocol, such as blue tooth, can be used. Also, in this embodiment, the mobile unit 12 and the processor 14 would each include a suitable antenna (not shown) to provide the wireless link. In an alternate embodiment, the unit 12 can be hardwired to the processor 14 by a suitable cable (not shown), such as a USB cable. Also, the unit 12 can be inserted into a cradle associated with the processor 14 to transfer the information.

The processor 14 processes the information sent from the unit 12, and accesses a store database 16 that includes an inventory of the available items in the store. The processor 14 formats and organizes the available items on the list from the unit 12 in a predetermined and convenient manner, such as combining related items on the list, for example, combining fruits and vegetables, that can be found at the same location in the store. Further, the processor 14 may identify where in the store, such as aisle number, the various items can be found. The processor 14 can also access other information from the database 16, such as applicable store and manufacturer sales and the like, that can be entered into the grocery list. The processor 14 can add suggested items to the list related to those items selected.

The unit 12 also transmits a user code with the list that identifies the user. The processor 14 decodes the user code, and determines if a user profile for that user is found in the database 16. The user profile could include information about user preferences, such as preferred brands, favorite items and related items to those that are identified that may not be particularly on the transmitted list. After the grocery list is formatted, organized and processed by the processor 14, it is sent to a printer 18 for printing. The user then will take the printed list into the store aisles to select the items thereon in the normal manner.

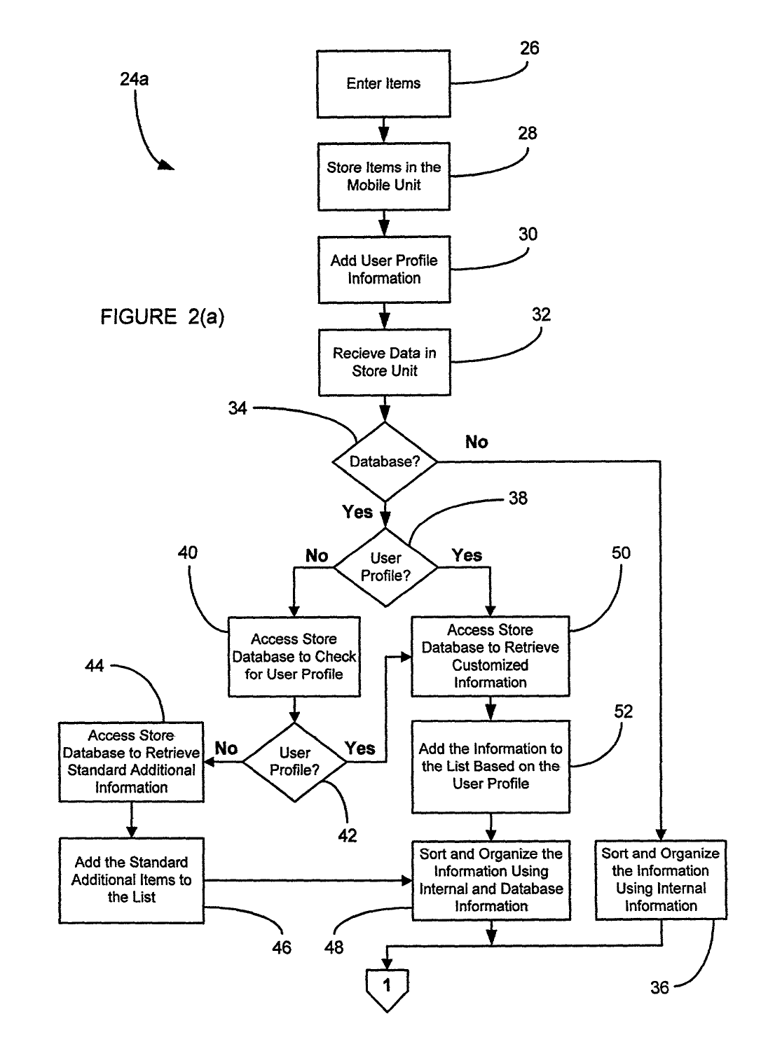

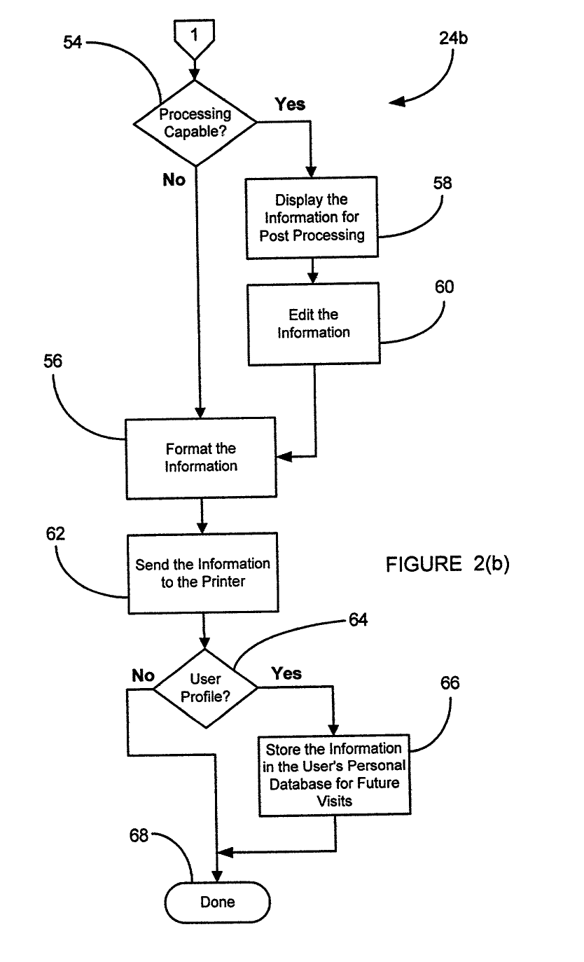

Any suitable software and system hardware that performs the operation discussed above can be employed in the system 10. FIGS. 2(a)-2(b) is a block diagram 24 more particularly identifying the operation of the system 10, according to the invention. At box 26, the user enters the items to be included in the grocery list into the unit 12 in any suitable manner as discussed herein. At box 28, the unit 12 stores the items entered therein in a predetermined manner by the system algorithms. At box 30, the mobile unit 12 adds user profile information to the list that may be transmitted to the processor 14. User profile information includes any relevant information that the user may have originally entered into the unit 12 to customize the system for that user, such as automatically add sour cream to the list if potatoes are entered as an item. The user can calibrate or “set-up” the unit 12 with his or her preferences initially, and then can add or change the preferences at any time thereafter.

When the user gets to the store, the grocery list and a user identification code are transmitted to the processor 14 using a transmission protocol of the type suggested herein, as depicted by box 32. When the processor 14 receives the grocery list from the unit 12, it determines whether a store database exists that is compatible with the system 10, as depicted at decision diamond 34. If the store does not include an applicable database, then the processor 14 formats, sorts and organizes the information on the grocery list by type of item so that like items are included together on the list or any other suitable organization scheme, as depicted at box 36. If the store database 16 does exist, then the processor 14 determines whether a user profile has been transmitted with the grocery list from the unit 12 at decision diamond 38. If no user profile is transmitted with the grocery list, then the processor 14 accesses the database 16 to determine whether a user profile is already stored for that particular user code at box 40. The processor 14 then determines whether a user profile does exist in the database 16 for that user at decision diamond 42.

If no user profile is transmitted with the grocery list from the unit 12, and no user profile is stored for the user code in the database 16, then the processor 14 uses standard predetermined information stored in the database 16 to be included with the grocery list at box 44. This standard information is not specific to a particular user, but is default information that the store personnel thinks that the user should be aware of based on the items that are in the grocery list, such as store sales, manufacturer sales, etc. This standard additional information is then added to the list by the processor 14 at box 46. The processor 14 then sorts and organizes the information using the standard information from the database 16 and preprogrammed organization processing in the processor 14 at box 48.

If the processor 14 determines that a user profile is stored for that particular user, then the processor 14 accesses the database 16 to retrieve particular customized information of the user preferences for that user, at box 50. This information is added to the grocery list based on this customized information at box 52. The processor 14 then sorts and organizes the grocery list using the customized information and the preprogrammed processing of the processor 14 at the box 48.

The system 10 then determines whether post-processing capabilities are available for the processor 14 at decision diamond 54 to determine whether the user can modify the list at the processor 14 prior to printing. If the processor 14 does not have the capability to allow the list to be modified by the user, then the processor 14 formats the information in the manner discussed herein at box 56. If the grocery list can be modified by the user at the processor 14, then the processor 14 displays the grocery list for post-processing at box 58. The processor 14 edits the information based on the user input at box 60, and then formats the information at box 56. The user edits the information by viewing the list prior to printing so that he can delete or add items as he wishes. The user can perform this post-processing by a keyboard, touch pad, etc. Once the grocery list is formatted, it is sent to the printer 18 at box 62.

The processor 14 then again determines whether a user profile is stored in the database 16 at decision diamond 64 so that it can be updated based on the new information transmitted to the processor 14. This step of the processing also allows the database 16 to store the updated user profile in the database 16. If no user profile is stored in the database 16, or no new user profile is transmitted to the processor 14, then the processor 14 goes into a stand-by mode for the next user at box 68. If a user profile is stored in the database 16, then the processor 14 stores or edits the user profile at box 66 for future visits and then goes into the standby mode at the box 68.

The foregoing discussion discloses and describes merely exemplary embodiments of the present invention. One skilled in the art will readily recognize from such discussion, and from the accompanying drawings and claims, that various changes, modifications or variations can be made therein without departing from the spirit and scope of the invention as defined in the following claims.

What is claimed is:

1. A system for storing, organizing and printing a list, said system comprising:
a mobile unit for entering items found in a store to the list, said mobile unit storing the items therein;
a processor for processing the list, said processor receiving the list from the mobile unit and organizing the list in a predetermined manner; and
a printer electrically coupled to the processor, said printer printing the organized list from the processor.

2. The system according to claim 1 further comprising a database, said database being electrically coupled to the processor and providing information to the processor concerning the list and/or a user, said information about the user being stored in the database as a user profile.

3. The system according to claim 1 wherein the mobile unit transmits the list to the processor by a wireless connection.

4. The system according to claim 1 wherein the mobile unit automatically adds items to the list in response to the items entered by a user based on pre-stored user preferences.

5. The system according to claim 1 wherein the mobile unit suggests items to be added to the list in response to the items entered by a user based on pre-stored user preferences.

6. The system according to claim 1 wherein the mobile unit automatically adds items to the list based on a pre-stored recipe.

7. The system according to claim 1 wherein the processor organizes and sorts the list based on location of the items on the list in the store.

8. The system according to claim 1 wherein the processor determines whether a user profile identifying user preferences is transmitted from the unit to the processor with the list.

9. The system according to claim 8 wherein the processor automatically adds items to the list based on user preferences identified in the user profile.

10. The system according to claim 8 wherein the processor stores and/or updates the user profile.

11. The system according to claim 1 wherein wherein the processor automatically adds store information to the list based on the items on the list.

12. The system according to claim 1 wherein the processor includes the ability to allow a user to edit the list prior to the printer printing the list.

13. The system according to claim 1 wherein the store is a grocery store.

14. A system for storing, organizing and printing a grocery store list, said system comprising:
a mobile unit for entering items found in the store to the list, said mobile unit storing the items therein, said mobile unit automatically adding items to the list in response to items entered by a user based on pre-stored user preferences in the mobile unit and said mobile unit suggesting items to be added to the list in response to the items entered by the user based on the pre-stored user preferences;
a store database storing information relating to items found in the store and other store information;
a processor for processing the list, said processor receiving the list from the mobile unit and organizing and sorting the list based on location of the items on the list in the store, said processor accessing the store database to add store information to the list based on the items on the list; and
a printer electrically coupled to the processor, said printer printing the organized list from the processor.

15. The system according to claim 14 wherein the mobile unit transmits the list to the processor by a wireless connection.

16. The system according to claim 14 wherein the database stores a user profile identifying user preferences, said processor adding items to the organized list identified in the user profile.

17. The system according to claim 14 wherein the processor determines whether a user profile identifying user preferences is transmitted from the unit to the processor with the list.

18. The system according to claim 17 wherein the processor automatically adds items to the list based on user preferences identified in the user profile.

19. The system according to claim 17 wherein the processor stores and/or updates the user profile.

20. The system according to claim 14 wherein the processor includes the ability to allow the user to edit the list prior to the printer printing the list.

21. The system according to claim 14 wherein the mobile unit automatically adds items to the list based on a pre-stored recipe.

22. A method of generating a shopping list comprising:
entering items into a mobile unit to be stored therein;
transmitting the stored items on the list from the mobile unit to a processor;
formatting and organizing the transmitted items in the processor; and
printing the organized list.

23. The method according to claim 22 wherein transmitting the stored items includes transmitting the stored items to the processor by a wireless connection.

24. The method according to claim 22 further comprising the step of automatically adding items to the list by the mobile unit in response to the items entered into the mobile unit.

25. The method according to claim 22 further comprising accessing a user profile by the processor to add items to the list based on a user preference.

26. The method according to claim 22 further comprising accessing a stored database to add information to the list about user preferences and/or store information.

27. The method according to claim 22 including editing the list based on a displayed stored list prior to printing the organized list.
